(19) United States
(12) Patent Application Publication
(10) Pub. No.: US 2010/0293821 A1
(43) Pub. Date: Nov. 25, 2010

(54) Layered Assembly

(75) Inventors: John C. Sullivan, Madison, CT (US); Jeffrey S. Samson, Irvine, CA (US); Pedro Vaca, Whittier, CA (US); Cory Price, Newport Beach, CA (US)

Correspondence Address: Pearne & Gordon LLP, 1801 East 9th Street, Suite 1200, Cleveland, OH, 44114-3108, US

(73) Assignee: Action Wobble, Inc., Irvine, CA (US)

(21) Appl. No.: 12/784,204

(22) Filed: May 20, 2010

Related U.S. Application Data
(60) Provisional application No. 61/179,884, filed on May 20, 2009.

(51) Int. Cl. G09F 19/00; G09F 3/10; B32B 33/00

(52) U.S. Cl. 40/1; 40/638; 428/40.1

(57) ABSTRACT

A layered assembly is provided including a base layer and a top layer. A pouch area is located between the base layer and the top layer and is created by affixing the base layer to the top layer. An opening is provided within a perimeter of the base layer to provide access to the pouch area through the base layer. An item can be loaded into the pouch area. Once the layered assembly is affixed to a substrate, the opening of the base layer is sealed off from access. A peel-away portion is located within a perimeter of the top layer such that removal of a portion of the top layer along the peel-away portion provides access to the pouch area through the top layer. Removal of the peel-away portion reveals the item that is secured within the layered assembly.

### CROSS REFERENCE TO RELATED APPLICATIONS

This application claims the benefit of U.S. Provisional Patent Application No. 61/179,884, filed on May 20, 2009 and entitled IMAGE POUCH.

### BACKGROUND OF THE INVENTION

1) Field of the Invention

The present invention relates to a layered assembly, and more particularly, to an assembly having two or more layers wherein the space between the layers provides a pouch area to receive an item.

2) Description of Prior Art

Greeting cards are typically printed with static designs and in large quantities. They can commonly be purchased at card stores such as Hallmark, bookstores and other retail locations. After a user purchases the greeting cards, she can handwrite personalized information on the greeting cards and mail them to family members, friends, or business clients. Card printing vending machines have been developed to allow the card purchasers to select the card designs and input their own personalized messages before the actual cards are printed.

In recent years, online photo services such as Shutterfly, Inc., based at Redwood City, Calif., have established services for users to upload, store and share their digital photo images. The users can order physical photo products such as photographic prints, photo books, CD's, etc. The print orders are fulfilled using automated digital printers, and shipped to the recipients as specified by the user. However, the users typically have to order the photo products in large quantities to save on setup and printing costs. Moreover, the photos are not separable from the products thereby limiting the use of the photo by the recipient of the product.

Also available are PHOTOSTAMPS, which allow users to take their own images or photographs and turn them into real U.S. postage via a service such as Stamps.com®. The users just need to upload a photo, customize it, and place their order. The stamps are then printed by the Stamps.com® company and sent to the user for use. However, when the recipient of the personalized stamp receives a letter, card, or package in the mail with the personalized stamp, the stamp by then has the cancellation mark across the stamp from the post office, thereby defacing the personalized image or photo.

Businesses can also take advantage of using personalized products. Using personalized images allows for many marketing opportunities. For instance, personalized images can be used for logos, product introductions, advertising, special events, corporate gifts, etc.

### SUMMARY OF THE INVENTION

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In accordance with an aspect of the present invention, a layered assembly is provided comprising a base layer having a first side and a second side, a first adhesive layer provided over the first side of the base layer, a second adhesive layer provided over the second side of the base layer, a top layer having a first side and a second side where the second adhesive layer is secured to the second side of the top layer, an opening within a perimeter of the base layer to provide access through the base layer, and a peel-away portion located within a perimeter of the top layer.

In accordance with another aspect of the present invention, a layered assembly is provided comprising a base layer having a first side and a second side, a first liner layer mounted to the first side of the base layer, a top layer having a first side and a second side and mounted to the second side of the base layer, a pouch area located between the base layer and the top layer, an opening located within a perimeter of the base layer to provide access to the pouch area through the base layer, and a peel-away portion located within a perimeter of the top layer such that removal of a portion of the top layer.

In accordance with another aspect of the present invention, a layered assembly is provided comprising a base layer having a first side and a second side, a first liner layer mounted to the first side of the base layer, a top layer having a first side and a second side and mounted to the second side of the base layer, a pouch area located between the base layer and the top layer, an opening located within a perimeter of the base layer to provide access to the pouch area through the base layer, and a peel-away portion located within a perimeter of the top layer such that removal of a portion of the top layer.

In accordance with another aspect of the present invention, a layered assembly is provided comprising a base layer having a first side and a second side, a first liner layer mounted to the first side of the base layer, a top layer having a first side and a second side and mounted to the second side of the base layer where at least a portion of the top layer includes a postage area, a pouch area located between the base layer and the top layer, an opening located within a perimeter of the base layer to provide access to the pouch area through the base layer, and a peel-away portion located within a perimeter of the top layer such that removal of a portion of the top layer.

The following description and the annexed drawings set forth in detail certain illustrative aspects of the invention. These aspects are indicative, however, of but a few of the various ways in which the principles of the invention may be employed and the present invention is intended to include all such aspects and their equivalents. Other objects, advantages and novel features of the invention will become apparent from the following detailed description of the invention when considered in conjunction with the drawings.

### BRIEF DESCRIPTION OF THE DRAWINGS

The foregoing and other features and advantages of the present invention will become apparent to those skilled in the art to which the present invention relates upon reading the following description with reference to the accompanying drawings.

FIG. 1 illustrates a front view of an example layered assembly on a surface.

FIG. 2 illustrates a perspective view of the layers included in an example of the layered assembly of FIG. 1.

FIG. 3 illustrates a front view of the layered assembly of FIG. 1.

FIG. 4 illustrates a rear view of the layered assembly of FIG. 1.

FIG. 5 illustrates a rear view of the layered assembly of FIG. 1 as an item is inserted into a pouch area of the layered assembly.

FIG. 6 illustrates a perspective view of the layered assembly of FIG. 5 with a tab portion partially opened for accessing the pouch area.

FIG. 7 illustrates a side view of FIG. 6 where an item is inserted into the pouch area of the layered assembly.

FIG. 8 illustrates a perspective view of the layers included in a second example of the layered assembly.

FIG. 9 illustrates a front view of a third example layered assembly with a postage area located on the interior of a perforated portion.

FIG. 10 illustrates a front view of a third example layered assembly with a postage area overlapping a perforated portion.

FIG. 11 illustrates a front view of a third example layered assembly with a postage area located on the exterior of a perforated portion.

FIG. 12 illustrates a front view of a third example layered assembly with a postage area in a horizontal orientation.

FIG. 13 illustrates a front view of a fourth example layered assembly.

FIG. 14 illustrates a front view of an example carrier sheet assembly in a vertical orientation that includes a plurality of layered assemblies.

FIG. 15 illustrates a rear view of FIG. 14.

FIG. 16 illustrates a front view of an example carrier sheet assembly in a horizontal orientation that includes a plurality of layered assemblies.

FIG. 17 illustrates a rear view of FIG. 16.

FIG. 18 illustrates a perspective view of at least one layered assembly on a carrier roll.

FIG. 19 illustrates a perspective view of a single pack for selling a plurality of layered assemblies.

FIG. 20 illustrates a perspective view of a two-sheet system for forming a layered assembly.

### DESCRIPTION OF EXAMPLE EMBODIMENTS

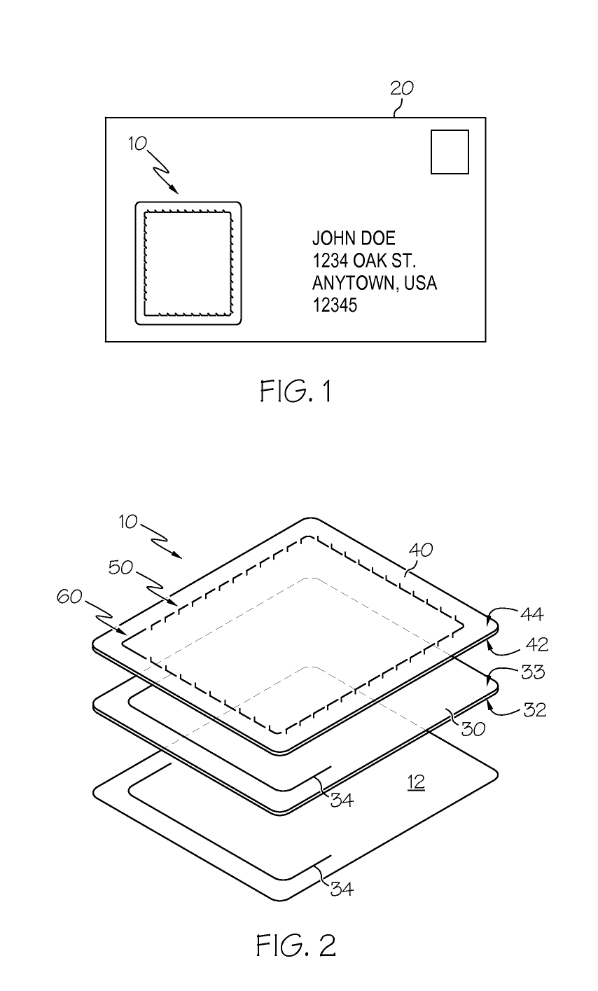

Referring initially to FIG. 1, a layered assembly 10 is shown. The layered assembly 10 is mounted on a substrate 20. The layered assembly 10 can be secured to a surface of a substrate 20, including but not limited to an envelope, a package, a mailer, a card, a magazine, a book, a food packaging, a textile, an article of clothing, an event invitation, or any other suitable material or structure. Any size or shape can be provided for each layered assembly 10.

As shown in FIG. 2, a perspective view of the layers included in an example layered assembly 10 is shown. The example layered assembly 10 includes a liner layer 12, a base layer 30, and a top layer 40. It is also to be appreciated that although the top layer 40 has been referred to herein as a top layer 40, any other suitable layer(s) can be positioned on top of the top layer 40. In other words, the top layer 40 does not necessarily mean the topmost layer of the image assembly. The top layer 40, the liner layer 12 and the base layer 30, or any other layer, can also be transparent, semitransparent, or even opaque and can have pictures or other text. Any of the layers, such as the top layer 40, can include various combinations of printing, text, images, and transparent windows or semi-transparent portions.

The base layer 30 includes a first side 32 and a second side 33. Images and/or text can be printed on either the first side 32 or the second side 33 to customize the base layer 30. Each side 32, 33 of the base layer 30 can be blank after manufacture, or one or both of the sides can be printed with image or text, or one or both of the sides can be pre-printed. Fragrances and/or scratch-off materials can also be provided on either the first side or the second side.

The liner layer 12 is mounted to the first side 32 of the base layer 30. The liner layer 12 is substantially covering the first side 32 of the base layer 30. The first side 32 of the base layer 30 can be a side that adheres or can include an adhesive layer. A coating can be provided to make the first side 32 of the base layer 30 adhere to other objects. The liner layer 12 can be a protective liner to protect an adhesive layer on the base layer 30 until the layered assembly 10 is ready to be adhered to a substrate 20, such as an envelope as shown in FIG. 1. The liner layer 12 can be peeled away from the base layer 30 to reveal the adhesive layer or sticky surface. After the liner layer 12 is removed, the layered assembly 10 can be sealed or attached to the substrate 20.

The top layer 40 includes a first side 42 and a second side 44. The first side 42 of the top layer 40 is mounted to the second side 33 of the base layer 30, as shown in FIG. 2. The base layer 30 is affixed or mounted to the top layer 40 in many different manners using many different structures. In one example, an adhesive can be provided along the outer portions of the base layer 30 and the top layer 40, such that the middle portions of the base layer 30 and the top layer 40 are free from adhesive or other attachment structures.

Images and/or text can be printed on either the first side 42 or the second side 44 to customize the top layer 40. Each side 42, 43 of the top layer 40 can be blank after manufacture, or one or both of the sides can be printed with image or text, or one or both of the sides can be pre-printed. In other examples, a partial portion or the entire portion of the top layer 40 can be transparent, partially transparent, or opaque. A fragrance and/or a scratch-off material can also be provided on either the first side 42 or the second side 44.

The top layer 40 can include a peel-away portion or any other peel-away structure. For example, the peel-away structure can include an outer portion that is a stickier that is able to be removed from the top layer 40 without any tearing occurring. Other examples of peel-away structures can also be provided. In this example, the peel-away portion is a perforated portion 50.

In the example of the perforated portion 50 can have a variety of shapes and sizes including but not limited to the shapes and sizes shown. The perforated portion 50 can be provided on just a portion of the inner portion 64 edge or can be provided fully around the edge of the inner portion 64 to facilitate ease of removal of a part of the inner portion 64 or the entire inner portion 64 of the top layer 40. In the example shown, the perforated portion 50 is of a rectangular shape within the interior of the top layer 40. The perforated portion 50 can be used to partially remove or entirely remove the top layer 40 from the assembly.

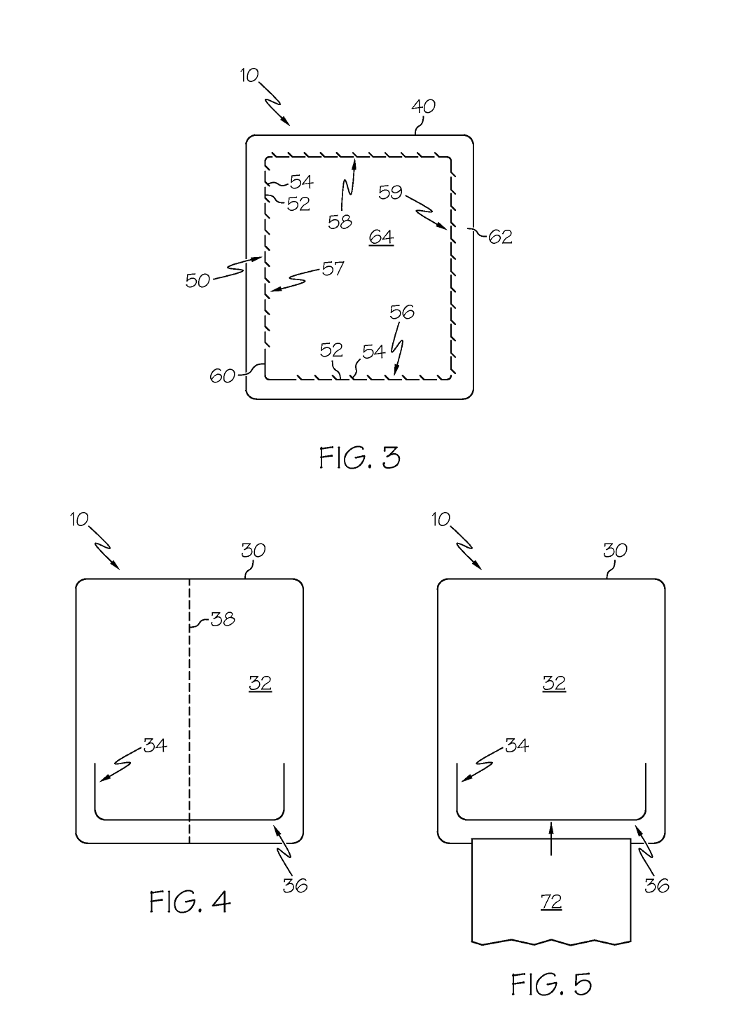

In a further example, at least one corner of the top layer 40 can have a peel-away tab 60. The peel-away tab 60 can be grasped and lifted by a user to peel off a portion of the top layer 40 to reveal an item 72 that is loaded within the layered assembly 10. The tabbed portion or the top layer 40 peel-away tab 60 can be created during manufacturing of the perforation or during a separate manufacturing step, such as a separate die-cut operation. It is to be appreciated that any suitable operation for creating the tab can be employed. An example of the top layer 40 is shown in FIG. 3, where the top layer 40 peel-away tab 60 has a rounded corner. Each other corner can also have a curved geometry to facilitate the smooth, easy removal of the perforated portion 50.

The top layer 40 can further include a frame portion 62 located on the exterior of the perforated portion 50 and an inner portion 64 on the interior of the perforated portion 50. Alternately or additionally, at least one corner of the inner portion 64 can include an easy-lift tab, such as the tab 60, or be otherwise suitably configured to facilitate easy removal of the inner portion 64 from the frame portion 62. As another alternative, the assembly 10 could be configured such that the entire top layer 40 can be removed by a user. The frame portion 62 can also include text, images, or indicia. For example, text can be provided in the frame portion 62 to indicate that an image is a United States stamp or to provide a caption for an image or text in the inner portion 64. For example, the frame portion 62 can have text stating “USA 440,” “USA First Class Forever,” etc.

The frame portion 62 is also configured to prevent or restrict inadvertent peel-away from another portion of the assembly 10. The frame portion 62 will have a slightly larger thickness relative to the other layers due to the presence of some amount of adhesive. For example, if another object or another piece of paper in the mail happens to slide across the layered assembly 10, the other object will slide over the frame portion 62 first and subsequently over the inner portion 64, which does not include adhesive. Thus, the other object will not interact with the tab. Accordingly, by restricting an inadvertent peel-away from the perforated portion 50, the layered assembly 10 provides a security feature for users in that it is visually recognizable to a user that the assembly is intact. If the perforated portion 50 is tampered with, it will indicate that another person has attempted to open the layered assembly 10. The layered assembly 10 makes it clearer to a user whether the layered assembly 10 had been tampered with or if the top layer 40 had been partially removed.

The top layer 40 is constructed from any suitable material, such as paper, plastic, or the like. Alternatively, the frame portion 62 can be constructed from a different material than the inner portion 64, if desired. It is to be appreciated that any suitable material(s) can be used for the frame portion 62 and the inner portion 64. Both materials should be configured to be durable enough to survive standard shipping, if used in that context. The frame portion 62 of the top layer 40 can be affixed permanently on all sides to the base layer 30. The inner portion 64 can then be removed to reveal one or more layers inserted between the base layer 30 and the top layer 40.

In this example, a zipper perforation is provided for the perforated portion 50, though other types of perforations can be provided. The zipper perforation is configured to allow a line of the perforated portion 50 to travel in multiple directions. Further, as shown more clearly in FIG. 3, the perforated portion 50 can be of a closed loop configuration, providing 360 degrees of travel as shown by the example quadrilateral shape for the line of the perforated portion 50. For instance, in the rectangular shape shown in FIG. 3, the perforated portion 50 includes both horizontal and vertical line-type perforations. Each individual cut of the perforation comprises an obtuse angle having a first leg 52 and a second leg 54, the first leg 52 being longer than the second leg 54. The perforation can be arranged such that the first legs 52 of the perforation cuts are positioned linearly along the edge desired to be separated. As shown in FIG. 3, the horizontal perforation cuts on a bottom portion 56 can be arranged such that the angles open to the right and the vertical perforation cuts on the left portion can be arranged such that the angles open to the right. When a line of the perforated portion 50 has at least one 90° turn in one direction, such as from the top-left edge to the top-edge, the first legs 52 and the second legs 54 of the perforation cuts will flip in orientation. Thus, while the left portion 57 has a second leg 54 extending towards the interior, the top portion 58 has a second leg 54 extending towards the exterior of the top layer 40. Alternatively, while the bottom portion 56 has a second leg 54 extending towards the interior, the right portion 59 has a second leg 54 extending towards the exterior of the top layer 40. The change in orientation is configured to allow the perforated portion 50 to tear smoothly around a corner. In addition, the angle between the first legs 52 and the second legs 54 opens in the same direction, to the right, along each portion 56, 57, 58, 59 in this example. Thus, perforations can be provided that extend in more than one direction. In addition, it is to be appreciated that any other suitable perforations and configurations can be employed with varying shapes and sizes that include a plurality of different legs and different orientations for the legs.

As shown in FIG. 4, a view of the base layer 30 and the liner layer 12 is shown. The liner layer 12 can be peeled away from the base layer 30 by providing a tab on any of the corners to reveal the adhesive layer or sticky surface of the first side of the base layer 30. Alternatively, the liner layer 12 can be peeled away by a user separating the liner layer 12 from the base layer 30 at any portion along the perimeter of the liner layer 12. In yet another example, a cut line 38 can be provided to divide the liner layer 12 into a plurality of portions such that a user can separate the liner layer 12 from another portion of the liner layer 12 and peel each portion of the liner layer 12 away from the base layer 30 to reveal the surface that adheres. In this example, a cut line 38 is provided vertically down the middle of the liner layer 12. In other examples, other directions and straight or curved shapes can be provided for the cut line 38. In other examples, other locations of the liner layer 12 can be removed such as by providing different cuts along the liner layer 12. The cut line 38 can be formed by any type of cut including but not limited to a kiss cut. The kiss cut is but one example of a cut line or other process that can be used and the liner layer 12 can include other types of other cuts and is not limited to including a kiss cut for the purpose of facilitating a removal of the liner layer 12. The liner layer 12 can include other structure for a user to easily peel off the liner layer 12 and to reveal a sticky surface on the base layer 30.

The layered assembly 10 is configured to be loaded with an item 72, such as a piece of media. The item 72 can include but is not limited to a photograph, a picture, a drawing, a z-fold item 72, an informational media, a brochure, a coupon, an advertisement, an object, or a wobble object as described in U.S. Patent Application No. 2005-0001113, the entirety of which is incorporated herein by reference. The item 72 can also be any other suitable insert that can be loaded within the layered assembly 10. The item 72 can also further be mounted on a spring assembly as described in U.S. Patent Application No. 2007-0089334, the entirety of which is incorporated herein by reference.

A recipient of a package or envelope can remove the inner portion 64 of the top layer 40 of the layered assembly 10 to reveal the wobble assembly within the pouch area that can be placed on the recipient's refrigerator, for example. Instead of or in addition to a wobble assembly, any other suitable item or items 72, such as a magnet, coupon, brochure, business card, photo, etc. can be provided under the inner portion 64 within the pouch area along with the item 72. The top layer 40 can be comprised of a material to protect the layer or layers underneath from damage during shipping.

An opening 36 located within a perimeter of the base layer 30 is also provided, as shown in FIG. 4 and FIG. 5. The opening 36 is provided along the base layer 30 and the liner layer 12, if present. The opening 36 is provided by a pouch cut in the base layer 30 and the liner layer 12. The top layer 40 is already attached to the base layer 30 such that the opening 36 will provide access into a pouch area located between the base layer 30 and the top layer 40. The pouch cut can be a single straight line such that a user can manipulate the layered assembly 10 to insert an item 72 into the opening 36, as shown in FIG. 5. The pouch cut can also have multiple segments and various curvatures to provide a variety of different types of openings. The pouch cut can be provided by a variety of different cutting operations.

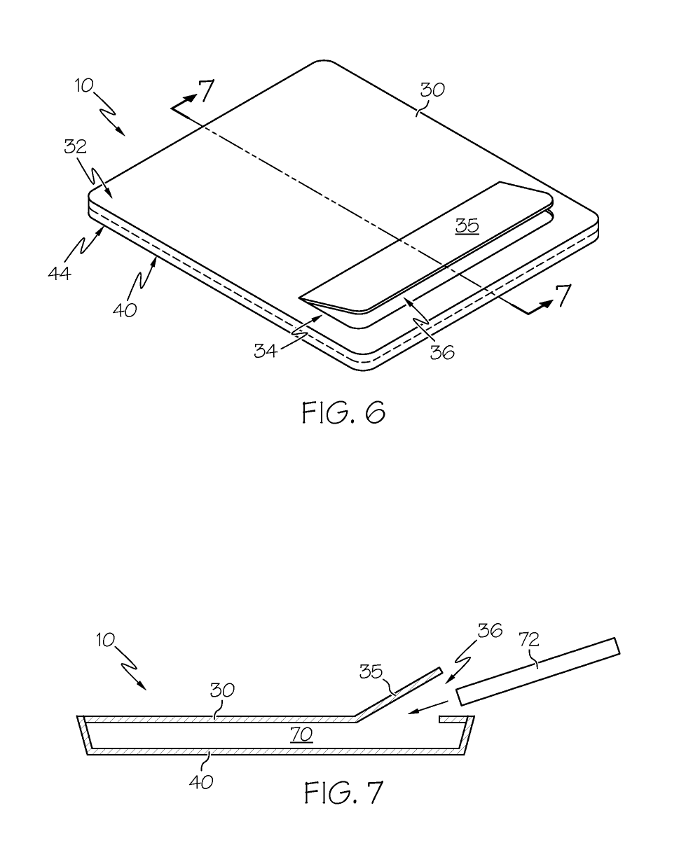

The pouch cut 34 through the base layer 30 and the liner layer 12 can provide a tab portion 35 to allow a user to manipulate the tab portion to easily insert an item 72 into the pouch area. The tab portion can be located within the base layer 30 to restrict a size of the opening 36. For example, the tab portion 35 can be lifted and/or opened by a user to access the opening 36 to the pouch area. As shown in FIG. 6, the tab portion can be manipulated away from the base layer 30 along a fold line. As shown in FIG. 7, by manipulating the tab portion away from the base layer 30, this will provide additional access for an item 72 of any size to be inserted into the pouch area. However, the pouch cut 34 can be configured in any desired manner (e.g., vertically, diagonally, etc.) and can be of any suitable shape (e.g., a car shape, a jean pocket shape, a circle, etc.) and size and will be contemplated as falling within the scope of the present invention. In this example, the pouch cut has a U-shape though other shapes can be provided. In still further examples, other structures can be provided for the tab portion 35 to restrict or block the opening 36.

FIG. 7 also shows an example of the pouch area 70 for the layered assembly 10. The pouch area 70 is the space located between the base layer 30 and the top layer 40. The pouch area 70 can extend along a substantial portion of the area between the base layer 30 and the top layer 40. This is just one example of the shape and size of the pouch area. As the base layer 30 and the top layer 40 can have minimal thicknesses corresponding to pieces of paper, the pouch area may only be as thick as the size of a piece of paper or a photograph in some examples. The base layer 30 and the top layer 40 can be mounted to each other in various manners. In one example, adhesive can be applied along the edges of the top layer 40 and the base layer 30 to ensure that any item 70 inserted into the pouch area are not able to fall out of the sides of the layered assembly 10. Other processes can also be used to form the pouch area.

A user can load the pouch area 70 of the layered assembly 10 with any item 72. If the liner layer 12 is provided, the first liner layer 12 can also have an opening the corresponds to the opening 36 in the base layer 30 such that access can be provided through both the opening in the first liner layer 12 and the opening 36 in the base layer 30. In this example, once the item 72 is positioned within the pouch area 70, the user can remove the protective liner layer 12 from the first side of the base layer 30 to reveal the adhesive layer. The user can then adhere the entire layered assembly 10, including the loaded item 72, to a suitable substrate 20. Because the entire first side of the base layer 30 is adhered to the substrate 20, such as an envelope, the pouch area 70 is effectively closed as the item 72 cannot be removed through the opening 36 provided by the pouch cut. Accordingly, the opening 36 of the base layer 30 is sealed off from access. The item 72 is concealed or hidden from view or access until the top layer 40 is peeled away. The item 72 is protected from both falling out of the pouch area 70 and from the environment. Once the layered assembly 10 is secured to a substrate 20, the item 72 is durable enough to survive shipping. Accordingly, because the top layer 40 is secured around its edges to the base layer 30, the item 72 can only be accessed by removing a portion of the top layer 40 of the layered assembly 10.

If desired, printing of images or text can be provided by the manufacturer or the user on the liner layer 12, on either side of the base layer 30, and on either side of the top layer 40. Thus, images and/or can be provided on the exterior of the pouch or within the pouch itself. For example, the liner layer 12 can include text with instructions on how to remove the liner layer 12, such as text instructing a user to “slide picture face down into pouch here,” in the view of FIG. 4.

The second side 33 of the base layer 30, shown in FIG. 2, can include text or images, such as the name and logo of a company that is visible within the pouch area 70. The text or images will be seen only upon a recipient removing a portion of the top layer 40 and removing the item 72 from the pouch area 70. The second side 33 of the base layer 30 is the portion of the base layer 30 visible after a portion of the top layer 40 is removed by manipulating the peel-away tab 60 is removed.

An image on the top layer 40 can refer to text, graphics, a cover graphic, or a theme, that is visible from the exterior of the pouch area 70. An image as well as text can be included on the top layer 40. For example, text can be pre-printed that tells a user to “peel to reveal photos & fun.” Text and images can be provided within the inner portion 64 and/or along the frame portion 62. In another example, a user can customize the top layer 40, such as by running the top layer through a printer, a laser printer, or an inkjet printer. It is also to be appreciated that the top layer 40 can be transparent, semitransparent, or even opaque such that the full image of the photograph or other media within the pouch area is either seen, partially seen, or not seen through the top layer 40. Fragrances and/or scratch-off materials can also be provided within the pouch on either the first side of the top layer 40 or the second side of the base layer 30.

In yet another example, a portion of the top layer 40 or even the entire top layer 40 can be a postage area. For example, the inner portion 64 of the top layer 40, shown in FIG. 3, can correspond to the postage area and include a pre-printed postage stamp, such as an image or an image of a bald eagle. Alternatively, the inner portion 64 of the top layer 40 can include a customized image or text, such as one selected from a website, for a postage stamp. In yet another alternative, the top layer 40 can be an area where a user will apply a postage stamp. Furthermore, the frame portion can include various indicia or text to signify that a pre-printed or customized postage stamp is valid, official, or legal. For example, the frame portion 62 can include text stating “USA 44¢,” “USA First Class Forever,” etc. In this example, the layered assembly 10 can generally correspond to the size of a postage stamp. The layered assembly 10 is configured to be a postage stamp accepted by a postal service, such as the U.S. Postal service. Consumer or manufacturers can place an item 72 within the pouch area 70. Thus, in the example where the top layer is a postage stamp, the postage stamp itself is configured to hold an item 72 in a pouch area 70 of the layered assembly 10.

Although not shown, the item 72 and/or the base layer 30 can be mounted on a spring assembly such that the item 72 and/or the base layer 30 can wobble in a clockwise and counterclockwise motion with respect to the base material or substrate 20 or other surface on which the layered assembly 10 is mounted. Thus, in one example, at least one item 72 can be loaded into the pouch area 70 of the layered assembly 10. The item 72 can be mounted onto a spring assembly or the pouch can have a spring assembly between the pouch and the base layer 30. The liner layer 12 can be released to attach the layered assembly 10 onto a substrate 20, such as an envelope. A recipient of the substrate 20 can peel the inner portion 64 off the front of the layered assembly 10 to reveal the item 72 that is mounted on a spring assembly and that can wobble. Both sides of the spring assembly can include one of a permanent, removable, or repositionable adhesive layer thereon. The base layer 30 can be permanently or removably coupled to the base material or substrate 20. It is to be further appreciated that any number and type of layers (flat layers, wobble layers, etc.) can be provided underneath the top layer 40. The spring assembly can be substantially similar to the spring assembly disclosed in co-pending U.S. Patent Application No. 2007-0089334, the entirety of which is incorporated herein by reference. However, it is to be appreciated that any other suitable spring assembly can be employed and is contemplated as falling within the scope of the present invention. Alternatively, or additionally, the base layer 30 can be coupled to one or more of a magnet, suction cup, hook and loop fastener, snap, rivet, button, or any other suitable structure and/or method.

A second example of the layered assembly 110 is shown in FIG. 8. The top layer 140 can have a laminate layer 180 applied to the second side of the top layer 140 to reinforce the top layer 140. The laminate can be provided on one or both of the first and second sides of the top layer 140. If the top layer 140 includes a perforated portion 150, the laminate layer 180 can also include a corresponding perforation. Likewise, if the top layer 140 is configured such that the user peels away the entire layer (e.g., not perforated), the laminate layer 180 will be configured to pull off with the entire top layer 140 (e.g., not perforated). It is to be appreciated that any other layer of the layered assembly 110 can also be laminated and is contemplated as falling within the scope of the present invention. The laminate layer 180 is configured to resist tearing of the top layer 140 as the inner portion of the top layer 140 is removed. The laminate layer 180 can be formed from a plastic material, though other materials can also be used. The laminate layer 180 has less of an ability to stretch than the paper that can be used to form the top layer 140. Thus, additional force is needed to tear it apart and this avoids the situation where the top layer 140 could be inadvertently torn by a user attempting to tear along a perforated portion 150. Accordingly, the laminate layer 180 provides additional strength to the top layer 140 to reduce the likelihood of the perforated portion 150 from popping or breaking as the inner portion of the top layer 140 is removed. The additional strength also is thus configured to improve the perforated portion 150 to break in a predictable manner. The laminate layer 180 can also provide the benefit of providing moisture protection for the item that is located in the pouch area. If a laminate layer 180 is provided, the top layer 140 can be pre-printed by a manufacturer to provide desired images and/or text.

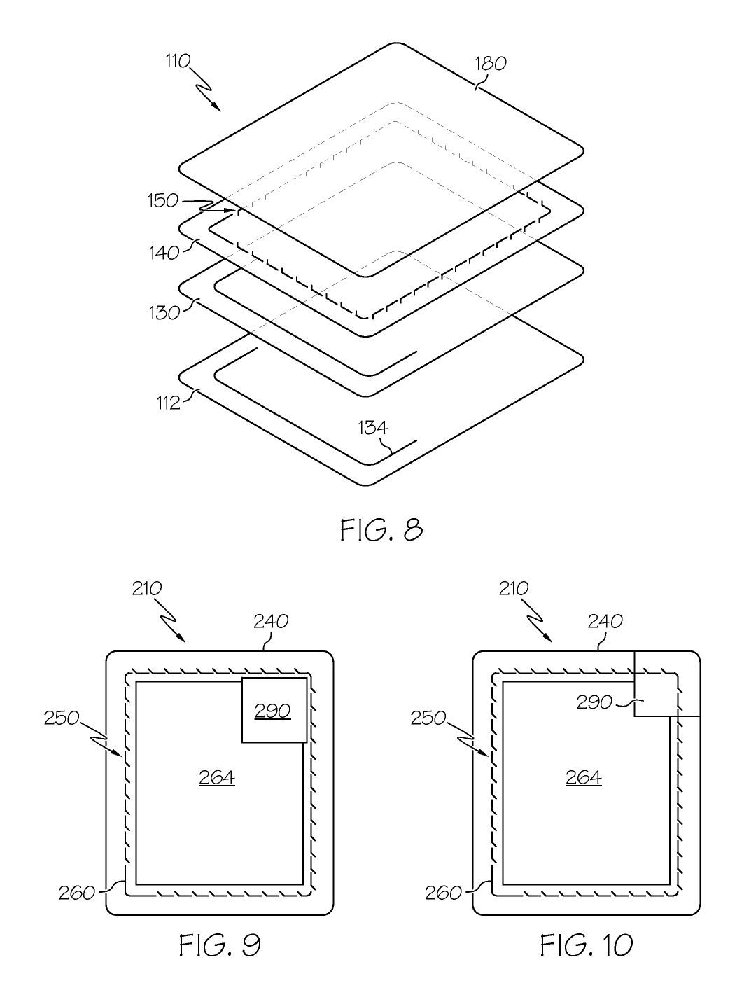

A third example of the layered assembly 210 is shown in FIG. 9 where a postage area 290 is provided. The postage area 290 is configured to correspond to at least a portion of the top layer, or even the entire top layer. The postage area 290 is configured to invite a user to apply a postage stamp. Alternatively, the postage area 290 is pre-printed with an image of a stamp. In yet another example, the postage area 290 is configured to be printed and/or customized with a stamp selected or customized by a user, such as through a web page. This postage area 290 can be located anywhere along the top layer 240 and can have any shape or size, including being the size of the entire layered assembly 210. The postage area 290 in this example is located on the interior of the perforated portion 250. In one example, the postage area 290 can be completely white, and can include text that states, “Place Stamp Here.” The third example can also include an inner portion 264 of the top layer 240 that can be transparent, partially transparent, or opaque.

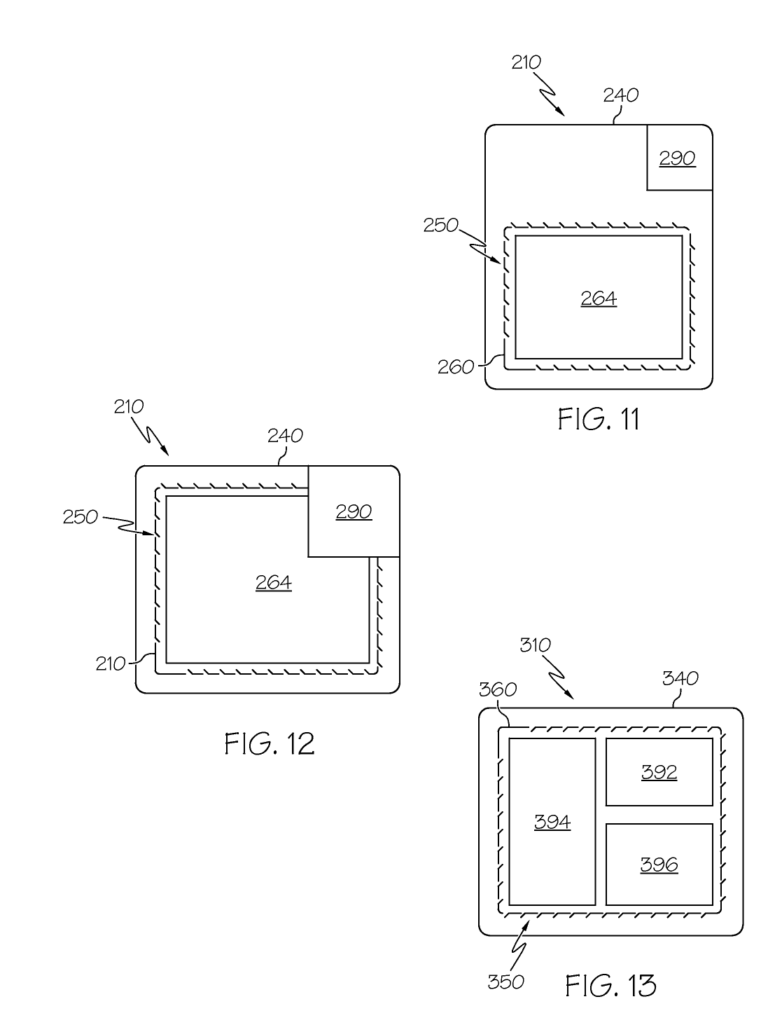

FIG. 10 shows an alternative arrangement for a layered assembly 210 with a postage area 290. In this example, the postage area 290 overlaps the perforated portion 250. FIG. 11 shows another alternative arrangement for a layered assembly 210. In this example, the postage area 290 is located on the exterior of the perforated portion 250. FIG. 12 shows yet another alternative arrangement for a layered assembly 210. In this example, the layered assembly 210 is in a horizontal orientation. In addition, the perforated portion 250 terminates at the postage area 290. This is just one example of the perforated portion 250 not completing a closed shape. The perforated portion 250 is still configured to allow enough of the top layer 240 to be removed. This example of the perforated portion 250 can also be used with any of the other examples in any of the other figures.

A fourth example of the layered assembly 310 is shown in FIG. 13, where an example layered assembly 310 is shown with a transparent window 394, a pre-printed indicia area 392, and a personalized area 396. The transparent window 394 can be of a size corresponding to the item located within the pouch of the layered assembly 310 or the window can be configured to reveal only a portion of the item. The personalized area 396 in this example can include any images or text, such as “Hello Grandma,” or “You are Invited!” In other examples, other shapes and sizes for the pre-printed indicia area 392, the personalized area 396, and the transparent window 394 can be provided. The top layer 340 can include portions that are a solid print, a semi-solid print, or a transparent cover. For example, the pre-printed indicia or the personalized area 396 can be provided on solid colors, semi-solid areas, or on top of a transparent portion.

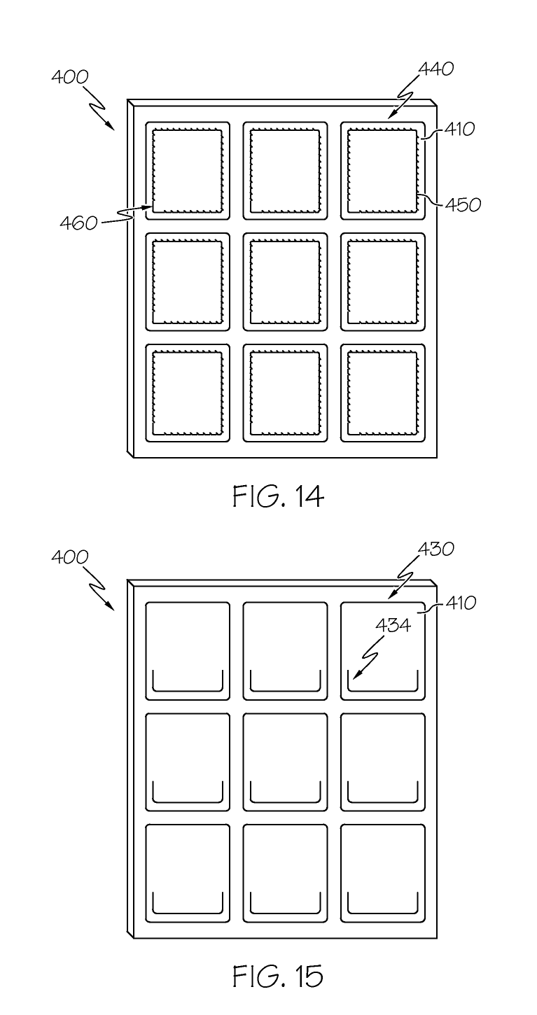

FIG. 14 shows a carrier sheet assembly 400 of nine layered assemblies 410. The layered assemblies can include any of the examples or any of the example features. The carrier sheet assembly 400 can be used to carry the layered assembly 410 assemblies and/or to transfer the layered assembly 410 assemblies to another structure. Each layered assembly 410 can be mounted to and detached from a carrier sheet assembly 400. The layered assemblies 410 can each have any size, shape, and any orientation relative to the carrier sheet assembly 400.

The base layer 430 and the top layer 440 can be assembled on top of the liner layer of the carrier sheet assembly 400. Other configurations and other amounts of layered assemblies 410 can be placed on a single sheet. The layered assembly 410 invention can also be provided to a consumer in an unfinished form such that the consumer could personalize the top layer 440. The top layer 440 can be substantially or entirely blank but could include the perforated portion 450 and instructions for removal of the perforated portion 450. Each layered assembly 410 also includes a peel-away tab 460 on a lower-left portion of each layered assembly 410. The peel-away tab 460 can be located on any of the other corners of the perforated portion 450. Alternatively, the peel-away tab 460 can also be in other locations along the perforated portion 450 and can have different shapes to facilitate the removal of a portion of the top layer 440. Accordingly, the user could position the layered sheet into a printer and print his/her own text and/or images onto the top layers 440 of the assemblies.

In another example, the carrier sheet assembly 400 can be of any shape or size, including but not limited to 4×6 or 8.5×11. The 8.5×11 example sheet includes nine layered assemblies, though other amounts of layered assemblies can be used. The 4×6 sheet can include two layered assemblies. The sheets can include any number of layered assemblies, including but not limited to one layered assembly or any number greater than one.

In yet another example, the carrier sheet assembly 400 can include the postage area 290 shown in the examples of FIGS. 9-12 or the pre-printed indicia area 392 and/or personalized area 396 of FIG. 13. In one example, a manufacturer can pre-print the image of a stamp into the postage area 290. In another example, the entire top layer 440 can be pre-printed as a stamp by a manufacturer. A consumer would then add the content of an item 70 to the layered assembly 410. In yet another example, a consumer can customize and print any text or images that they desire into the postage area 290. In this example, text or other indicia can still be pre-printed onto the layered assembly 410 to prove that the stamp is a genuine stamp. In a still further example, text can be included or pre-printed outside of the perforated portion 450.

In yet another example, the carrier sheet assembly 400 can include any of the features from any of the other examples in each of the layered assemblies 410. Alternatively, the layered assemblies 410 on a carrier sheet assembly 400 can have a variety of different features, despite being located on the same carrier sheet assembly 400.

FIG. 15 shows a back side of the nine layered assemblies 410 of FIG. 14 on the same carrier sheet assembly 400. The back side corresponds to the base layer 430 and the liner layer. In this view, the openings from a pouch cut 434 corresponding to each pouch area can be seen. The pouch cut 434 can be located on any portion of the base layer 430 and can extend in any direction. In this example, the pouch cut 434 is located near a bottom portion of the base layer 430. The base layer 430 can be substantially or entirely blank. Other indicia or pre-printed indicia, such as security indicia (not shown), trademark indicia, removal instructions, and/or any other functional and/or decorative images can be provided on the top layer 440 shown in the front view of FIG. 8, the base layer 430, or on the liner layer, or on any other layer that is provided.

A user can remove any or all of the layered assemblies of FIG. 14 and FIG. 15 by a variety of methods. The layered sheet could be perforated or include cut lines for the user to easily separate the layered assembly 410 assemblies for use as described herein above. In one example, a perforated portion, such as a micro-perforation is provided. A micro-perforation is configured to provide a relatively quick way for a user to detach each individual layered assembly 410 from the carrier sheet. In one example, a micro-perforation can be provided by a dash-dot repeating pattern, though other patterns can also be used. Thus, when a user removes one of the layered assemblies 410 from the carrier sheet assembly 400, attaches the individual layered assembly 410 face down onto a substrate, and a user peels off the top layer 440, the item will be revealed to the user.

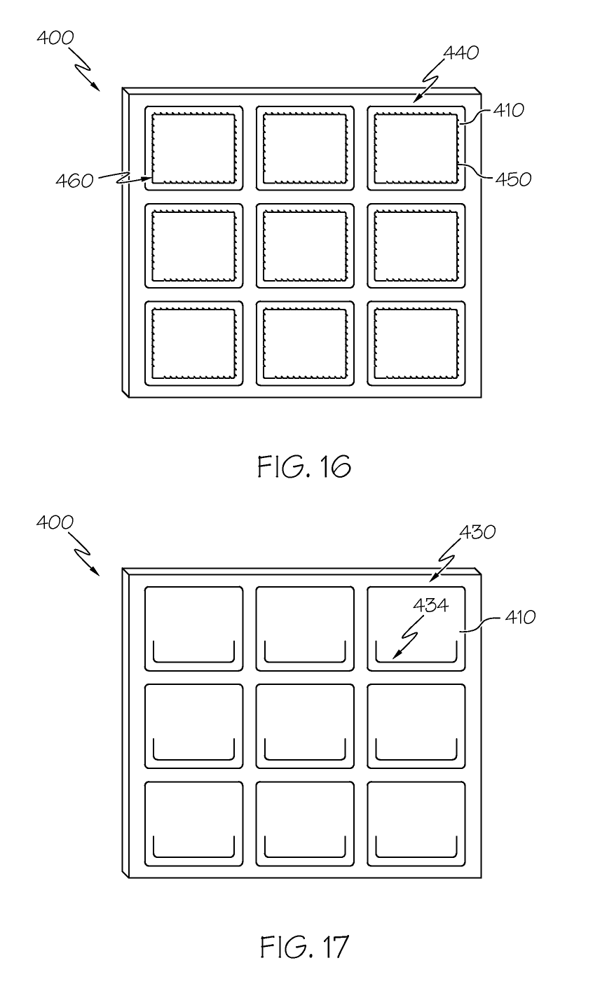

FIG. 16 shows a carrier sheet assembly 400 of nine layered assemblies 410. The example of FIG. 16 is the same as FIG. 14 except that FIG. 16 has a horizontal orientation for the carrier sheet assembly. Each layered assembly 410 also includes a peel-away tab 460 on a lower-left portion of each layered assembly 410. The peel-away tab 460 can be located on any of the other corners of the perforated portion 450. Alternatively, the peel-away tab 460 can also be in other locations along the perforated portion 450 and can have different shapes to facilitate the removal of a portion of the top layer 440.

FIG. 17 shows a back side of the nine layered assemblies 410 of FIG. 16 on the same carrier sheet assembly 400. The back side corresponds to the base layer 430 and the liner layer. The example of FIG. 17 is the same as FIG. 15 except that FIG. 17 has a horizontal orientation for the carrier sheet assembly. In this view, the openings from a pouch cut 434 corresponding to each pouch area can be seen. The pouch cut 434 can be located on any portion of the base layer 430 and can extend in any direction. In this example, the pouch cut 434 is located near a bottom portion of the base layer 430.

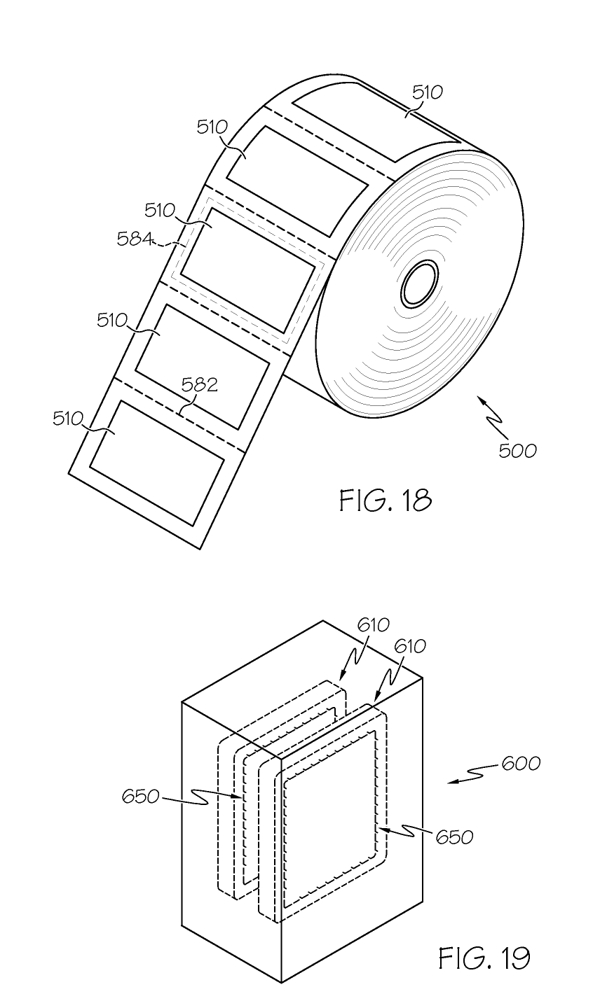

Alternatively, a plurality of layered assemblies 510 can be provided on a carrier roll 500, as shown in FIG. 18. The layered assemblies 510 can each have any size, shape, and any orientation relative to the carrier roll 500. A carrier roll 500 can provide a first type of perforated portion 582 to allow users to easily tear off the amount of layered assemblies 510 they desire. In addition or alternatively, a second type of perforated portion 584 can be provided around each individual layered assembly. The second type of perforated portion 584 can substantially correspond to the shape of the layered assembly 510, though other shapes can also be provided.

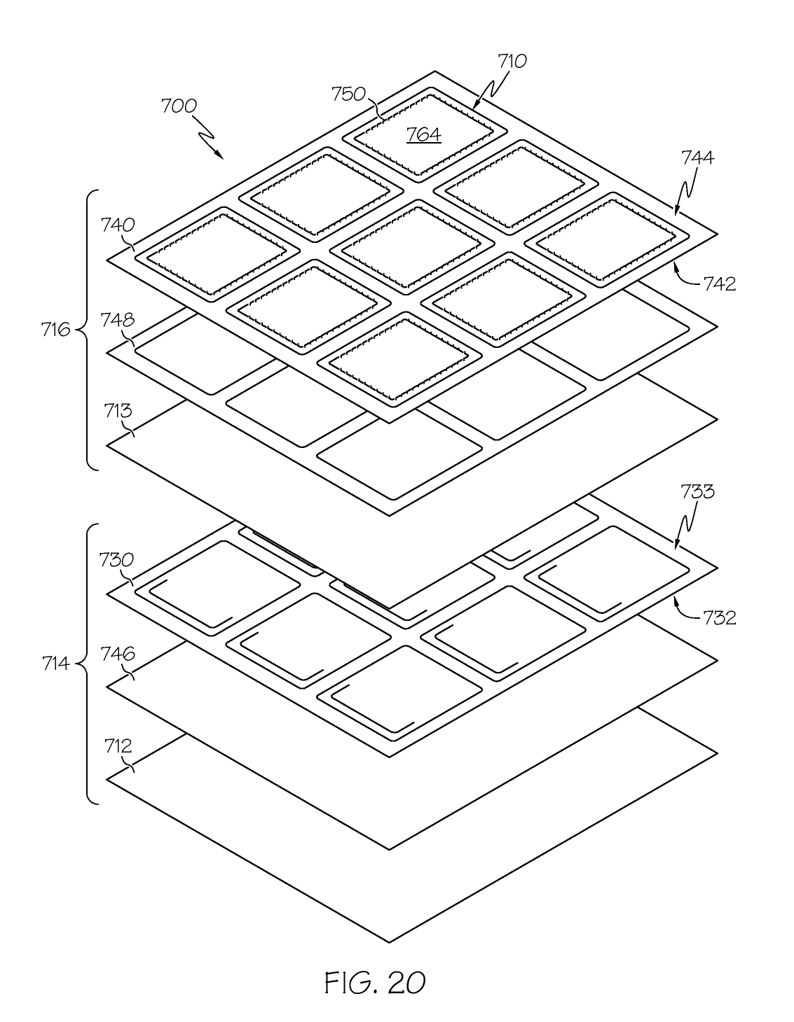

In yet another alternative shown in FIG. 19, layered assemblies 610 can be sold in multiples in a single pack 600. The layered assemblies 610 can be carried by the single pack 600, sold in the single pack 600, or retrieved from the single pack 600. The layered assemblies 610 can each have any size, shape, and any orientation relative to the single pack 600. The single pack 600 can include any amount of layered assemblies 610, including but not limited to sets of 2, 3, 4, 10, 20, or 25 layered assemblies 610. The single pack 600 can have a variety of openings on the outer surface for retrieving one or all of the layered assemblies 610 located within the single pack. The openings of the single pack 600 can also have a variety of closure or resealable mechanisms along any portion of the outer surface of the single pack 600. When packaged together, each of the layered assemblies can have similar or pre-printed images or text corresponding to a certain event, such as a birthday or an anniversary. In addition, the front of the single pack 600 can have an image or text corresponding to the pre-printed images or text on the layered assemblies 610. Alternatively, the front of the single pack 600 can have an image or text that does not correspond to the pre-printed images or text on the layered assemblies 610. The layered assemblies 610 can also include perforated portions 650 or any of the other features from the other examples. In a still further example, each of the layered assemblies can be blank such that a user can customize the layered assemblies.

FIG. 20 shows a perspective view of a two-sheet system 700 for forming a single layered assembly 710. The layered assemblies 710 can each have any size, shape, and any orientation relative to the two-sheet system 700. In this example, nine layered assemblies 710 will be formed, though in other examples, even a single layered assembly 710 can be formed by using a two-sheet system 700. The two-sheet system 700 can be used to form either a single layered assembly or a plurality of layered assemblies. In this example, users are provided with the single layered assembly 710 that includes a first sheet 714 and a second sheet 716. The first sheet 714 includes a base layer 730 having a first side 732 and a second side 733, a first adhesive layer 746 provided over the first side 732 of the base layer 730, and a first liner layer 712 provided over the first adhesive layer 746. The second sheet 716 includes a top layer 740 having a first side 742 and a second side 744, a second adhesive layer 748 provided over the first side 742 of the top layer 740, and a second liner layer 713 provided over the second adhesive layer 748. Any of the other examples already discussed for the base layer 730, the liner layer 712, the top layer 740, the opening 736, the pouch area 770, and the tab portion can also be used in the two-sheet system.

A user is able to print any images or text on the second side of the base layer 730 and a user can also print any images or text on the second side of the top layer 740. When a user has customized the first sheet 714 and the second sheet 716 as desired, a user can then assemble the first sheet 714 onto the second sheet 716. Thus, the second liner layer 713 is removed such that the second adhesive layer 748 is provided over the second side of the base layer 730. The second adhesive layer 748, in one example, covers only a minimal outer portion of the top layer 740 such that a pouch area 770 is located in the space between the base layer 730 and the top layer 740.

Once the first sheet 714 is secured to the second sheet 716, a user can load an item into the pouch area through the use of the opening 736 in the base layer 730. An opening 736 is provided within the perimeter of the base layer 730 to provide access to the pouch area through a portion of the base layer 730. The opening 736 can be provided by a pouch cut. After the item is loaded, the first liner layer 712 can be removed to expose the first adhesive layer 746. The layered assembly 710 can then be adhered onto a substrate. Once the layered assembly 710 is affixed to the substrate, the opening 736 of the base layer 730 is sealed off from access. A peel-away portion, such as a perforated portion 750, can be located within a perimeter of the top layer 740 such that removal of a portion of the top layer 740 along the perforated portion 750 provides access to the pouch area through a portion of the top layer 740. The recipient of the layered assembly 710 can then remove an inner portion 764 of the top layer 740 by tearing along the perforated portion 750 that extends around the inner portion 764 to reveal the item loaded and secured in the pouch area within the layered assembly 710.

What has been described above includes example implementations of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations of the present invention.

It should be evident that this disclosure is by way of example and that various changes may be made by adding, modifying or eliminating details without departing from the scope of the teaching contained in this disclosure. The invention is therefore not limited to particular details of this disclosure except to the extent that the following claims are necessarily so limited.

1. A layered assembly comprising:
a base layer having a first side and a second side;
a first adhesive layer provided over the first side of the base layer;
a second adhesive layer provided over the second side of the base layer;
a top layer having a first side and a second side wherein the second adhesive layer is secured to the second side of the top layer;
an opening within a perimeter of the base layer to provide access through the base layer; and
a peel-away portion located within a perimeter of the top layer.

2. The layered assembly of claim 1, further comprising:
a first liner layer mounted to the base layer substantially covering the first side of the base layer; and
a second liner layer mounted to the top layer substantially covering the second side of the top layer.

3. The layered assembly of claim 1, further comprising:
a first liner layer mounted to the base layer substantially covering the first side of the base layer, wherein the first liner layer is configured to be removed from the base layer to reveal the first side of the base layer that is configured to adhere to a substrate, wherein the substrate includes one of the following: an envelope, a package, a mailer, a card, a magazine, a book, a food packaging, a textile, or an event invitation.

4. The layered assembly of claim 1, further comprising:
a first liner layer mounted to the base layer substantially covering the first side of the base layer, the first liner layer having an opening therein that corresponds to the opening in the base layer such that access can be provided through both the opening in the first liner layer and the opening in the base layer.

5. The layered assembly of claim 1, further comprising a tab portion within the base layer to restrict a size of the opening.

6. The layered assembly of claim 5, wherein the tab portion is formed by a pouch cut through the base layer.

7. The layered assembly of claim 1, wherein the top layer includes a transparent portion.

8. The layered assembly of claim 1, further comprising a spring assembly coupled between an item and the second side of the base layer.

9. The layered assembly of claim 1, wherein the first side and the second side of the base layer have images printed thereon.

10. The layered assembly of claim 1, further comprising a carrier sheet upon which the layered assembly can be mounted and detached from.

11. The layered assembly of claim 1, further comprising a carrier roll upon which the layered assembly can be mounted and detached from.

12. The layered assembly of claim 1, further comprising a single pack upon which the layered assembly can be retrieved from.

13. The layered assembly of claim 1, wherein the peel-away portion is a zipper perforation that includes a shape with at least one 90° turn in one direction.

14. The layered assembly of claim 1, further comprising a laminate layer on top of the top layer and configured to resist tearing of the top layer as the peel-away portion of the top layer is removed.

15. The layered assembly of claim 1, further comprising at least one of a fragrance or a scratch-off material located on at least one of the top layer or the base layer.

16. The layered assembly of claim 1, further comprising: a pouch area located between the base layer and the top layer, wherein removal of a portion of the top layer along the peel-away portion provides access to the pouch area through the top layer.

17. The layered assembly of claim 16, further comprising: an item located in the pouch area, wherein the item is at least one of: a photograph, a picture, a drawing, a z-fold item, an informational media, a brochure, a coupon, an advertisement, or a wobble object.

18. A layered assembly comprising:
a base layer having a first side and a second side;
a first liner layer mounted to the first side of the base layer;
a top layer having a first side and a second side and mounted to the second side of the base layer;
a pouch area located between the base layer and the top layer;
an opening located within a perimeter of the base layer to provide access to the pouch area through the base layer; and
a peel-away portion located within a perimeter of the top layer such that removal of a portion of the top layer along the peel-away portion provides access to the pouch area through the top layer.

19. The layered assembly of claim 18, further comprising a second liner layer mounted to the top layer substantially covering the second side of the top layer.

20. The layered assembly of claim 19, wherein the first liner layer is configured to be removed from the base layer to reveal the first side of the base layer that is configured to adhere to a substrate and the substrate includes one of the following: an envelope, a package, a mailer, a card, a magazine, a book, a food packaging, a textile, or an event invitation.

21. The layered assembly of claim 18, wherein the first liner layer has an opening therein that corresponds to the opening in the base layer such that access can be provided through both the opening in the first liner layer and the opening in the base layer.

22. The layered assembly of claim 18, further comprising a tab portion within the base layer to restrict a size of the opening.

23. The layered assembly of claim 22, wherein the tab portion is formed by a pouch cut through the base layer and the first liner layer.

24. The layered assembly of claim 18, further comprising a carrier sheet upon which the layered assembly can be mounted and detached from.

25. The layered assembly of claim 18, further comprising a carrier roll upon which the layered assembly can be mounted and detached from.

26. The layered assembly of claim 18, further comprising a single pack upon which the layered assembly can be retrieved from.

27. The layered assembly of claim 18, wherein the peel-away portion is a zipper perforation that includes a shape with at least one 90° turn in one direction.

28. The layered assembly of claim 18, further comprising a laminate layer on top of the top layer and configured to resist tearing of the top layer as the peel-away portion of the top layer is removed

29. The layered assembly of claim 18, further comprising: an item located in the pouch area, wherein the item is at least one of: a photograph, a picture, a drawing, a z-fold item, an informational media, a brochure, a coupon, an advertisement, or a wobble object.

30. A layered assembly comprising:
a base layer having a first side and a second side;
a first liner layer mounted to the first side of the base layer;
a top layer having a first side and a second side and mounted to the second side of the base layer, wherein at least a portion of the top layer includes a postage area;
a pouch area located between the base layer and the top layer;
an opening located within a perimeter of the base layer to provide access to the pouch area through the base layer; and
a peel-away portion located within a perimeter of the top layer such that removal of a portion of the top layer along the peel-away portion provides access to the pouch area through the top layer.

31. The layered assembly of claim 30, wherein the postage area corresponds to an inner portion located within the peel-away portion.

32. The layered assembly of claim 30, wherein the postage area corresponds to an inner portion located within the peel-away portion and the inner portion includes a pre-printed postage stamp.

33. The layered assembly of claim 30, wherein the postage area corresponds to an inner portion located within the peel-away portion and the inner portion includes a customized postage stamp.

34. The layered assembly of claim 30, wherein the postage area corresponds to an inner portion located within the peel-away portion and the top layer further includes a frame portion on the exterior of the peel-away portion, and wherein the frame portion includes at least one of an indicia or text configured to signify that the postage area includes a valid postage stamp.

35. The layered assembly of claim 30, wherein the first liner layer is configured to be removed from the first side of the base layer to reveal the first side of the base layer that is configured to be mounted on a substrate and the substrate includes one of the following: an envelope, a package, a mailer, a card, a magazine, a book, a food packaging, a textile, or an event invitation.

36. The layered assembly of claim 30, further comprising a carrier sheet upon which the layered assembly can be mounted and detached from.

37. The layered assembly of claim 30, further comprising a carrier roll upon which the layered assembly can be mounted and detached from.

38. The layered assembly of claim 30, further comprising a single pack upon which the layered assembly can be retrieved from.

39. The layered assembly of claim 30, further comprising a tab portion within the base layer to restrict a size of the opening.

40. The layered assembly of claim 30, wherein the peel-away portion is a zipper perforation that includes a shape with at least one 90° turn in one direction.

41. The layered assembly of claim 30, further comprising a laminate layer on top of the top layer and configured to resist tearing of the top layer as the peel-away portion of the top layer is removed

42. The layered assembly of claim 30, further comprising: an item located in the pouch area, wherein the item is at least one of: a photograph, a picture, a drawing, a z-fold item, an informational media, a brochure, a coupon, an advertisement, or a wobble object.
